(19) United States
(12) Patent Application Publication
(10) Pub. No.: US 2021/0336978 A1
(43) Pub. Date: Oct. 28, 2021

(54) METHOD FOR IMPLEMENTING HETEROGENEOUS DATABASE SYNCHRONIZATION IN SECURITY ISOLATION GAP BASED ON DATA STREAM ANALYSIS

(71) Applicants: Bluedon Information Security Technologies Corp., Guangzhou (CN); Bluedon Information Security Technologies Co., Ltd., Guangzhou (CN)

(72) Inventors: Zonggui Ke, Guangzhou (CN); Baoming Zhang, Guangzhou (CN); Xiaoning Qin, Guangzhou (CN)

(21) Appl. No.: 16/857,148

(22) Filed: Apr. 23, 2020

(51) Int. Cl. H04L 29/06; H04L 29/08; G06F 16/27; G06F 16/25

(52) U.S. Cl. CPC H04L 63/1425; G06F 16/258; G06F 16/27; H04L 67/1095

(57) ABSTRACT

The present invention discloses a method for implementing heterogeneous database synchronization in a security isolation gap based on data stream analysis. The method includes the steps of connecting a non-secret-related external network database via an Open Database Connectivity (ODBC) database driver, monitoring a port of a source database server for packet capture and analysis, extracting data, converting the data into a self-defined format, sending the data to a target database via an internal private protocol of an isolated card of the gap, then converting the data into a target database format when the data is synchronized to a target database, and sending analyzed data to an outer end of the uni-directional gap, thus completing data synchronization between the source database and the target database.

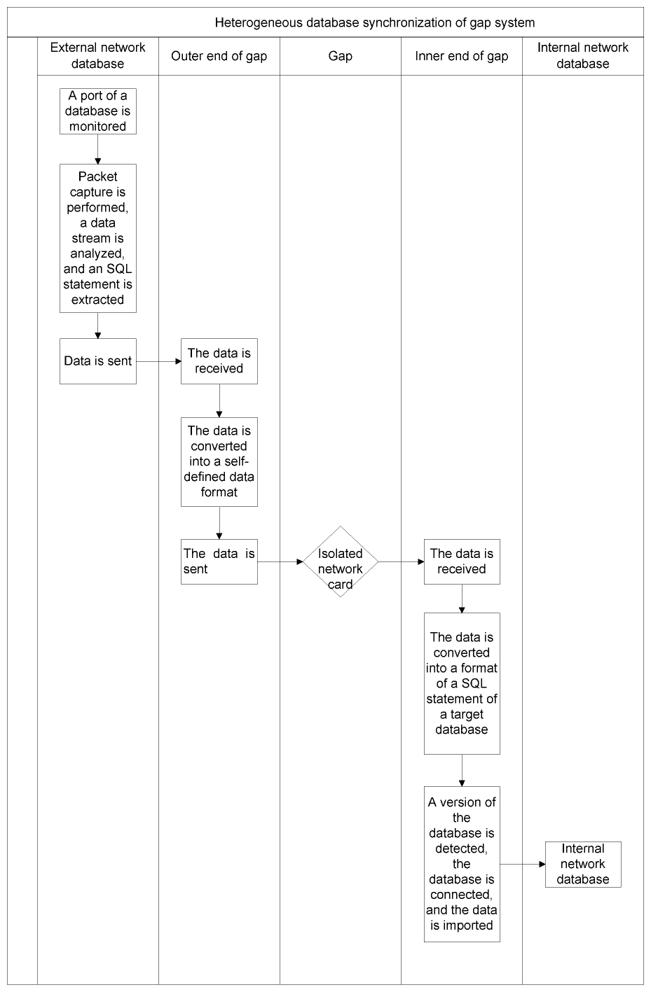

### TECHNICAL FIELD

The present invention relates to the technical field of data processing, and in particular to a method for implementing heterogeneous database synchronization in a security isolation gap based on data stream analysis.

### BACKGROUND

The State Secrets Bureau and the State Council Informatization Office jointly issued E-Government Secrets Management Guide in 2007. It is stipulated in the Guide that “according to the technical requirements on information secrets, the secret-related network cannot be directly connected to the Internet; and when the secret-related network is connected to the non-secret-related network, if the non-secret-related network is isolated from the Internet physically, a bidirectional gap is used to isolate the connection between the secret-related network and the non-secret-related network, thus guaranteeing that secret-related data does not flow from a confidence network to a non-confidence network”.

A core of the gap lies in an isolation switching control unit. The isolation switching control unit controls that the network only allows uni-directional connection at a same moment to form a physical spatial isolation. It takes the effect of ferrying data in gap isolation control. The isolation switching control unit controls connection and disconnection of a network switching channel. A data switching buffer area is provided in the switching control unit, and takes the effect of a ferry in a data switching process. At present, two common switching channel control technologies are a ferry switch and channel control. The ferry switch is an electronic reversing switch, which allows the data switching area not to connect an internal network and an external network simultaneously at any time to form the uni-directional connection, and seems to be a space interval to implement the physical isolation. The channel manner is to change a communication mode between the internal network and the external network, so that the internal network and the external network are not connected directly; and such a manner uses a private communication technology to form the physical isolation between the internal network and the external network.

### SUMMARY

The present invention implements, via a manner of monitoring a port of a source database server for packet capture and analysis, data synchronization of a heterogeneous database in a uni-directional gap system. The uni-directional gap system includes an inner end and an outer end.

1. A resident monitoring program deployed in the source database server is configured to monitor the port of the monitoring server and perform the packet capture and analysis, extract data such as a Structured Query Language (SQL) statement, and send the data to a receiving module on the outer end of the uni-directional gap device.

2. The data receiving module on the outer end is configured to connect the resident monitoring program of the source database server, receive data sent from the resident monitoring program, and forward the data to a data format conversion module on the outer end.

3. The data format conversion module on the outer end is configured to uniformly convert the received data in a format of the SQL statement into a self-defined data format, such as an Extensive Markup Language (XML) format.

4. A data receiving module on the inner end is configured to receive data sent from the outer end of the gap.

The technical solutions of the present invention have the following beneficial effects:

By monitoring a port of a source database server in real time, analyzing a data stream to extract an SQL statement and sending the SQL statement in real time, the present invention greatly reduces a delay rate of data synchronization, and improves the data synchronization performance; and moreover, as a monitoring port program is a resident service program, all data streams flowing through the port can be monitored and captured, and thus the present invention can solve a problem of the data synchronization between heterogeneous data, reduces the occupation for a database resource of a user, and is a portable, high-performance and low-consumption data synchronization manner.

### BRIEF DESCRIPTION OF THE DRAWINGS

In order to describe the technical solutions in the embodiments of the present invention or in the conventional art more clearly, a simple introduction on the accompanying drawings which are needed in the description of the embodiments or conventional art is given below. Apparently, the accompanying drawings in the description below are merely some of the embodiments of the present invention, based on which other drawings may be obtained by those of ordinary skill in the art without any creative effort.

The sole FIGURE is a flowchart of the present invention.

### DETAILED DESCRIPTION OF THE EMBODIMENTS

The present invention is further described below in detail in combination with the accompanying drawings. The described detailed embodiments are merely one part of the present invention, rather than a limit for the present invention.

As shown in the FIGURE, the solutions have the following implementation process:

1. On a source database server of an external network, a service program for monitoring a port of a source database of the external network is deployed and started, to perform packet capture and analysis on a database statement in a packet, and extract dml and ddl operation statements for the database.

2. The service program for monitoring the port sends data to an outer end of a uni-directional gap via SOCKET.

3. The outer end receives the data, and forwards the data to a data format conversion module on the outer end to convert the data into a self-defined data format.

4. A data sending module on the outer end sends the data via a uni-directional light-splitting link to a database receiving module on an inner end of the uni-directional gap.

5. The data receiving module on the inner end receives data sent from the outer end.

6. A data format conversion module on the inner end converts the data into a format required by a target database of an internal network.

7. A heterogeneous database synchronization module on the inner end detects a type and a version of the database, loads a corresponding database driver program to connect the database, and synchronizes the data to a database on the inner end, thus completing uni-directional synchronization of the data.

For example:

A packet capture program for monitoring a port of a server mainly uses winpcap (a windows platform) and libpcap (a linux platform) development libraries for packet capture. The winpcap/libpcap allows an application program to have a capability of accessing an underlying layer of a network and can detect a data packet captured to a physical link. A part of sample codes when the winpcap monitors the packet capture of a 1521 port in an oracle database server are set forth hereinafter:

| pcap_if_t *all_dev | |
|---|---|
| pcap_if_t *d; | |
| //Find all network devices | |
| if (pcap_findalldevs_ex(PCAP_SRC_IF_STRING, NULL, &all_dev, NULL) == −1) | |
| { | |
| | return 0; |

}
//Get a target network device for the packet capture
d = getTargetDev(all_dev);
//Open a target network card
pcap_t *pHandle = pcap_open(d−>name, 65536, PCAP_OPENFLAG_PROMISCUOUS,

500, NULL, NULL);

| if(pHandle == NULL) | |
|---|---|
| { | |
| | pcap_freealldevs(all_dev); |
| | return −1; |
| } | |
| //Data packet in an Ethernet | |
| if(pcap_datalink(pHandle) != DLT_EN10MB) | |
| { | |
| | pcap_freealldevs(all_dev); |
| | return −1; |
| } | |
| //Mask address | |
| bpf_u_int32 netmask; | |
| if(d−>addresses) | |
| { | |
| netmask=((structsockaddr_in *)(d−>addresses−>netmask))−>sin_addr.S_un.S_addr; | |
| } | |
| else | |
| { | |
| | //Simplify the processing, and default a C type of network address: 255.255.255.0 |
| | netmask = 0xffffff; |

}
//Compile a filter rule, and only capture a data packet meeting the rule (a tcp packet of

the port 1521, that is, the port of the oracle database service; different ports are used for
different database servers)

| struct bpf_program bpfRule; | |
|---|---|
| if(pcap_compile(pHandle, &bpfRule, “ip and tcp and port 1521”, 1, netmask) < 0) | |
| { | |
| | pcap_freealldevs(all_dev); |
| | return −1; |
| } | |
| //Set the filter rule | |
| if (pcap_setfilter(pHandle, &bpfRule) < 0) | |
| { | |
| | pcap_freealldevs(all_dev); |
| | return −1; |

}
pcap_freealldevs(all_dev);
//Start to capture the packet and process the data packet (HandleDelPacket is a callback

function for analyzing and processing the data packet)

pcap_loop(pHandle, −1, HandleDelPacket, NULL).

Through the above process and sample codes, it can be seen that the solutions of the present invention can completely implement the heterogeneous database synchronization of the uni-directional gap by monitoring the data stream at the port of the server.

The above gives a detailed introduction to a method for implementing heterogeneous database synchronization in a security isolation gap based on data stream analysis provided by the embodiments of the present invention. In the specification, a specific example is used to describe a principle and an implementation manner of the present invention. The description on the above embodiments is merely helpful to understand a method and a core concept of the present invention. Meanwhile, those of ordinary skill in the art may make a change within a scope of the specific implementation manners and applications according to a concept of the present invention. To sum up, the content in the specification should not be understood as a limit to the present invention.

What is claimed is:

1. A method for implementing heterogeneous database synchronization in a security isolation gap based on data stream analysis, comprising steps of connecting a non-secret-related external network database driver via an Open Database Connectivity (ODBC) database, monitoring a port of a source database server for packet capture and analysis, extracting data, converting the data into a self-defined format, sending the data to a target database via an internal private protocol of an isolated card of the gap, then converting the data into a target database format when the data is synchronized to the target database, and sending analyzed data to an outer end of a uni-directional gap, thus completing data synchronization between the source database and the target database.

2. The method for implementing the heterogeneous database synchronization in the security isolation gap based on the data stream analysis as claimed in claim 1, monitoring the port of the source database server for the packet capture and analyse, extracting the data such as a Structured Query Language (SQL) statement, and sending the data to a receiving module on the outer end of the uni-directional gap device.

3. The method for implementing the heterogeneous database synchronization in the security isolation gap based on the data stream analysis as claimed in claim 1, uniformly converting received the data in a format of a SQL statement into the self-defined data format, then converting the data into the target database format when the data is synchronized to the target database, and sending the analyzed data to the outer end of the uni-directional gap, thus implementing the data synchronization.
